(19) United States
(12) Patent Application Publication
(10) Pub. No.: US 2007/0208956 A1
(43) Pub. Date: Sep. 6, 2007

(54) Energy efficient inter-processor management method and system

(75) Inventors: Jyh-Han Lin, Parkland, FL (US); Charbel Khawand, Miami, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/993,524

(22) Filed: Nov. 19, 2004

(51) Int. Cl. G06F 1/26

(52) U.S. Cl. 713/300

(57) ABSTRACT

A mobile device (106) comprising a processing system (206) including an inter-processor manager (308), and a plurality of processors (304-306) coupled to the inter-processor manager, wherein two or more of the plurality of processors are capable of processing a service application, and wherein the inter-processor manager is programmed to receive (402) a request to delegate the service application to at least one of the plurality of processors, select (406) an optimal one of the plurality of processors (304-306) to execute the service application according to a plurality of projected energy consumptions of the service application corresponding to each of the plurality of processors, and delegate (408) the service application to the optimal processor for execution.

### FIELD OF THE INVENTION

This invention relates generally to multi-processor systems, and more particularly to an energy efficient method and system for multi-processor architectures.

### BACKGROUND OF THE INVENTION

Emerging mobile communications are increasingly multi-media rich and often involve concurrent processing and memory intensive operations like location-based services, navigation services, video (recording, playback, streaming), text-to-speech synthesizers, and speech recognition, just to name a few.

To address these applications, designers of mobile devices are employing multi-processor architectures such as, for example, an (possibly multi-core) ARM (Advanced Risk Machines) combined, or integrated, with a DSP (Digital Signal Processor) intercommunicating with conventional inter-processor protocols.

The drawback of this approach is that mobile devices with the foregoing architecture suffer from a limited battery life performance when compared to single processor architectures. Furthermore, existing multi-processor architectures also typically have a less than optimal load management scheme. The embodiments of the invention presented below overcome these deficiencies in the prior art.

### SUMMARY OF THE INVENTION

Embodiments in accordance with the invention provide an apparatus and method for substantially improving the efficiency of a mobile device.

In a first embodiment of the present invention, in a processing system comprising an inter-processor manager coupled to a plurality of processors, wherein two or more of the plurality of processors are capable of processing a service application, a method in the inter-processor manager comprising the steps of receiving a request to delegate the service application to at least one of the plurality of processors, selecting an optimal one of the plurality of processors to execute the service application according to a plurality of projected energy consumptions of the service application corresponding to each of the plurality of processors, and delegating the service application to the optimal processor for execution.

In a second embodiment of the present invention, a mobile device, including a processing system comprising an inter-processor manager, and a plurality of processors coupled to the inter-processor manager, and wherein two or more of the plurality of processors are capable of processing a service application, and wherein the inter-processor manager is programmed to receive a request to delegate the service application to at least one of the plurality of processors, select an optimal one of the plurality of processors to execute the service application according to a plurality of projected energy consumptions of the service application corresponding to each of the plurality of processors, and delegate the service application to the optimal processor for execution.

### BRIEF DESCRIPTION OF THE DRAWINGS

FIG. 1 is an illustration of a communication system communicating with a number of mobile devices in accordance with an embodiment of the present invention.

FIG. 2 is a block diagram of the mobile device of FIG. 1 in accordance with an embodiment of the present invention.

FIG. 3 is a block diagram of a processing system in accordance with an embodiment of the present invention.

FIG. 4 is a flow chart depicting a method for substantially improving the energy efficiency of the mobile device in accordance with an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

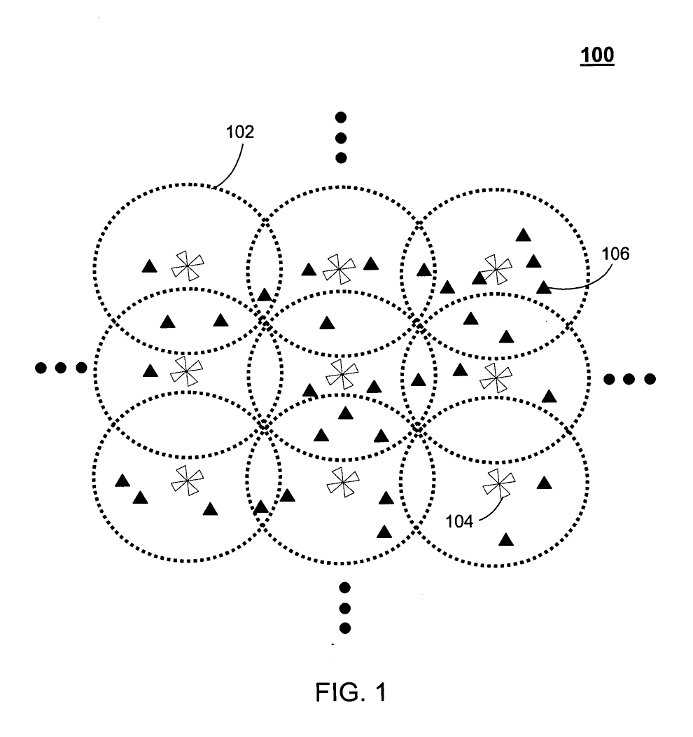

Referring to FIG. 1, an illustration of a communication system 100 communicating with a number of mobile devices 106 is shown. The communication system 100 is a conventional wireless network comprising a plurality of radio base stations 104, each covering a geographic cell site 102, which in the aggregate cover, for example, a metropolitan area.

In this system 100, the mobile device 106 may take the form of a conventional cellular phone, or other radio communications device (e.g., a wireless PDA coupled to a wireless local area network). It would obvious to one of ordinary skill in the art, however, that the embodiments herein are applicable to a non-wireless mobile device 106 such as, for example, a portable gaming device (e.g., GameBoy™), a DVD video player, and so on. More broadly speaking, the embodiments described below can be applicable to any device where energy efficiency brings economic value to a vendor of the mobile device 106 independent of the application.

For illustration purposes only, the description below will focus on a mobile device 106 with wireless capability. All alterations and additions to the proceeding description of the embodiments of the invention leading to an equivalent structure, that is, a structure that presents the same function, way and result as the embodiments described herein is intended to be within the scope and spirit of the claims below.

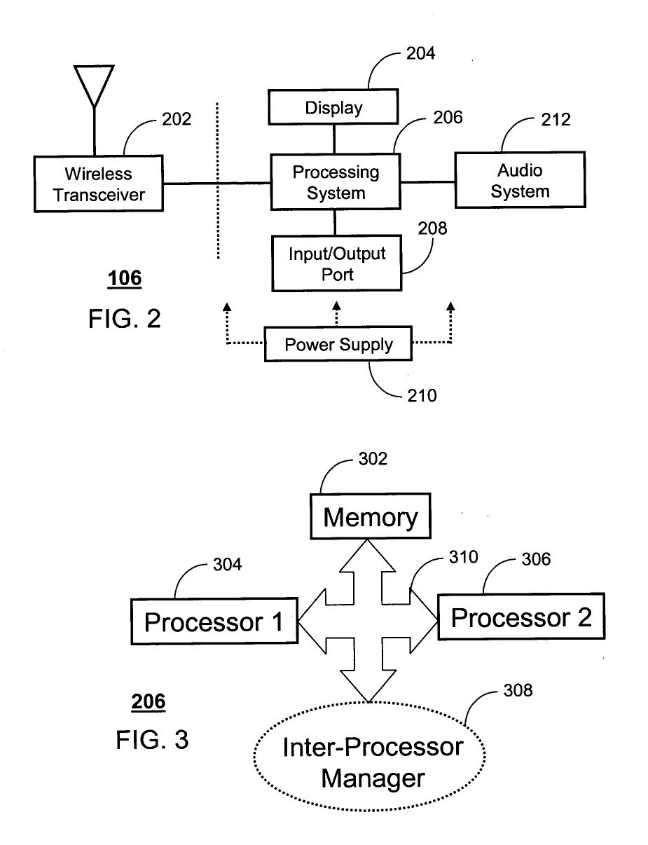

FIG. 2 shows a more detailed view of the mobile device 106. The mobile device 106 can include conventional components such as a wireless transceiver 202, a display 204, an input/output port 208, a battery supply 210, and an audio system 212. The hashed line next to the wireless transceiver 202 corresponds to an alternative embodiment characterized by a non-wireless mobile device 106 such as described above.

A processing system 206 is the processing center for the mobile device 106, which controls operations of the foregoing components 202-212. The processing system 206 for instance controls voice processing (e.g., voice calls), multi-media processing (video MPEG 4 player), data message processing (e.g., application downloads, short message system exchanges, etc.) and other house-keeping functions of the mobile device 106.

FIG. 3 shows an expanded view of the processing system 106, comprising a conventional memory 302, a plurality of processors 304-306 (shown by way of example as first and second processors) and an inter-processor manager 308. The memory 303 may be a single or a combination of conventional memory devices (e.g., dynamic random access memory, flash memory, etc.) operated on individually or jointly by the elements 304-308 of the processing system 106.

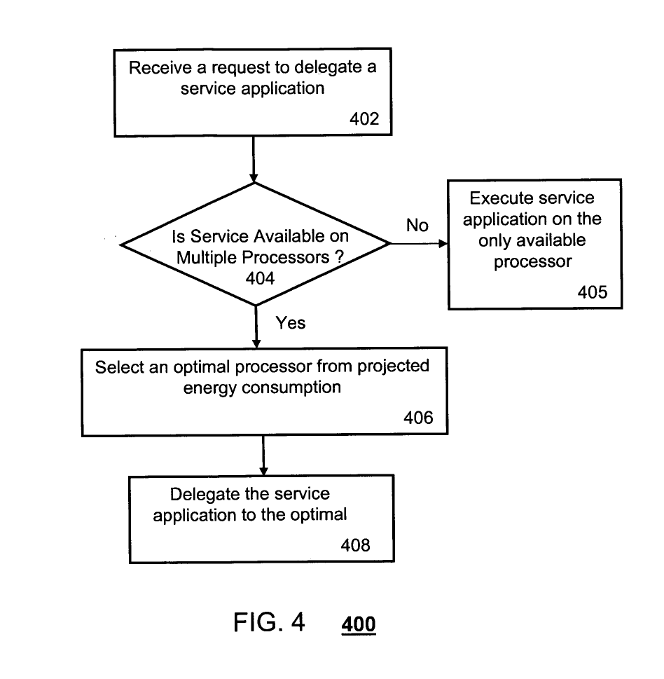

The plurality of processors 304-306 can employ conventional processing elements, each capable of executing in whole or in part software such as a service application employing any algorithm (e.g., a video player) or instructions in its most elemental form (e.g., microcode of a CISC processor). The inter-processor manager 308 may comprise a conventional application specific integrated circuit (ASIC), a microprocessor, a state machine, or other processing means that is capable of operating according to the method 400 of FIG. 4 as described below. Alternatively, the processing function of the inter-processor manager 308 can take the form of hardware, software or combinations thereof operating in whole or in part from the first or second processors 304, or independent hardware.

The processing elements 302-308 of the processing system 206 are interconnected by a conventional communication bus 310. The bus 310 construction can be physical or logical. In the former, the physical connection may be a conventional serial or parallel bus for transmitting signals between devices sourced by a conventional transceiver (e.g., universal asynchronous receiver transmitter—UART, or universal serial bus—USB driver). Alternatively, a portion or whole of the communication bus 310 may represent a logical connection such as software components sharing data structures. The processing elements 302-308 coupled to the communication bus 310 can be represented in a single integrated circuit (IC) device with sub-elements operating therein, or a combination of ICs, each operating as a corresponding one of the elements 302-308 of the processing system 206.

The flow chart of FIG. 4 depicts a method 400 in the inter-processor manager 308 for substantially improving the energy efficiency of the mobile device 106. We begin with step 402, where the inter-processor manager 308 receives a request to delegate a service application to at least one of the plurality of processors 304-306. The delegation request can originate from any number of sources.

For instance, the mobile device 106 may operate from a conventional operating system (OS) such as Linux (or a smaller customized kernel) designed to submit a request to the inter-processor manager 308 every time a service application has been invoked. Alternatively, requests from the OS may come only part of the time such as when a service application is known to consume large amounts of processing cycles measured by, for example, MIPS (Million Instructions Per Second). The frequency of requests made to the inter-processor manager 308 is a design parameter that can be adjusted according to the application. The higher the frequency the more likely the embodiments of the invention will provide energy savings to the mobile device 106.

In step 404, if the service application can run on multiple processors, the inter-processor manager 308 proceeds to step 406; otherwise, it proceeds to step 405 where the service application is processed by the only available (or capable) processor in the processing system 206.

In step 406, the inter-processor manager 308 selects an optimal one of the first and second processors 304-306 to execute the service application according to a plurality of projected energy consumptions of the service application corresponding to each of the processors 304-306. In a first embodiment, the plurality of projected energy consumptions can be predetermined. For example, each service application can be prescreened to determine the projected energy consumptions of the application on the components 202-212 of the mobile device 106.

Alternatively, or in combination with the foregoing embodiment, the plurality of projected energy consumptions are based on corresponding historical energy consumption data collected from real-time operation of the service application on at least one of the plurality of processors 304-306. For instance, after a power-up cycle of the mobile device 106, the inter-processor manager 308 can use the predetermined energy consumptions if no historical data has been developed on the service applications that can be executed by the processing system 206. When sufficient data is gathered, however, the inter-processor manager 308 switches to a historical approach for determining the projected energy consumption of a particular service application. Alternatively, the historical data can be stored and maintained in a portion of the memory 302 in which case the inter-processor manager 302 applies the last known projected energy consumptions of corresponding service applications.

The historical data can be processed by the inter-processor manager 308 (or a background process) by way of conventional statistical or straightforward mathematical methods for projecting energy consumption of a service application. Moreover, several means for measuring energy consumption can be used by the inter-processor manager 308.

For example, a metric for measuring energy consumption can consist of projected MIPS of a service application. These metric may be predetermined according to products of conventional analysis software such as, for example, a CASE (Computer-Assisted Software Engineering) tool for examining the software components (or instructions) of the service applications that operate in the processing system 206. Alternatively, the inter-processor manager 308 with less sophisticated but similar software to the CASE tool may measure the MIPS for each service application in real-time.

Another metric the inter-processor manager 308 can use in the selection method is a reading of the remaining energy in the battery 210 that supplies energy to components of the mobile device 106. This energy reading can be derived by conventional means such as a reading of the voltage level of the battery 210 under loading conditions and using known characterization data of the battery 210 to translate this voltage to a remaining energy level of the battery. The inter-processor manager 308 can weigh the selection decision among the first and second processors 304-306 versus the impact to battery life of the mobile device 106 in using this metric.

In yet another embodiment, the inter-processor manager 308 selects any one of the first and second processors 304-306 according to a plurality of loading conditions corresponding to the processors 304-306. Similar to the preceding description, the loading conditions can be predetermined, or historically developed from data gathered during real-time operation of each of the service applications on the processors 304-306. Additionally, these loading conditions may be translated into energy consumption rates (or running averages) of the processors 304-306, which can be used by the inter-processor manager 308 as additional energy consumption statistics to assist in the selection process.

In a more complex embodiment, the inter-processor 308 can select either processor 304-306 according to an optimal pair of the projected energy consumptions of the service application and loading conditions of the processors 304-306. In addition, each projected energy consumption and loading condition may be weighted by predetermined criteria. The predetermined criteria can be based on, for example, a scoring system, which gives a score to each projected energy consumption and loading conditions of the processors 304-306. The score has positive and negative offsetting effects. For instance, a negative score may be driven by penalties (e.g., fast processing needs of the service application), while a positive score may be driven by order of importance, priority, and/or potential energy savings.

There may be situations where the scoring system weighs loading conditions with greater importance than energy consumptions. For example, where a service application requires high MIPS, such as video processing to provide a good user experience by way of the display 204, the optimal processor may be chosen primarily on loading conditions and secondarily on energy consumption benefits. Where, however, both benefits (MIPS and energy savings) can be delivered equally, the scoring system used for loading and energy consumption can be weighted equally or nearly equal. It is up to the mobile device 106 designer to choose a scoring system that defines a scheme for selecting an optimal processor.

In a simpler embodiment, however, the inter-processor manager 308 can be programmed to choose the optimal processor according to the processor 304 or 306 having the lowest projected energy consumption for processing the service application.

As should be evident by now, any number of complex embodiments can be developed for the selection process of step 406. For example, the inter-processor manager 308 can be programmed to select an optimal processor according to an optimal combination of one of the projected energy consumptions of the service application and the group comprising singly or in combination a select one of the loading conditions, remaining energy in the battery 210, speed of processing the service application in each of the processors 304-306, and a priority of the service application.

Accordingly, any modifications to the embodiments described above, or additional metrics used for measuring energy not mentioned above leading to equivalent structures and methods as described herein are considered within the scope of the claimed invention.

In view of the embodiments above, proceeding to step 408 is straightforward. That is, the service application is delegated to the optimal processor selected in step 406 for execution such that energy efficiency can be substantially improved for the mobile device 106.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents. The claims are sufficiently general to include equivalent structures.

For example, a software implementation of a method and a hardware implementation of the same method may not be structural equivalents in that the software implementation is dependent on a processing system for execution, while the hardware implementation may have self-contained processing means. It is well known in the art, however, that software and hardware implementations may be designed to be equivalent structures generating the same results. Accordingly, all equivalent modifications and additions to the description above are intended to be inclusive of the scope the following claims.

1. In a processing system comprising an inter-processor manager coupled to a plurality of processors, wherein two or more of the plurality of processors are capable of processing a service application, a method in the inter-processor manager comprising the steps of:
receiving a request to delegate the service application to at least one of the plurality of processors;
selecting an optimal one of the plurality of processors to execute the service application according to a plurality of projected energy consumptions of the service application corresponding to each of the plurality of processors if no historical data has been developed on the service applications;
if historical data has been developed switching to an optimal one of the plurality of processors based on historical energy consumption data collected from real-time operation of a particular service application; and
delegating the service application to the optimal processor for execution.

2. The method of claim 1, wherein the plurality of projected energy consumptions of the service application are predetermined.

3. The method of claim 1, wherein the plurality of projected energy consumptions of the service application are based on corresponding historical energy consumption data collected from real-time operation of the service application on at least one of the plurality of processors.

4. The method of claim 1, wherein the optimal one of the plurality of processors has the lowest projected energy consumption of the plurality of projected energy consumptions of the service application.

5. The method of claim 1, wherein the selecting step further comprises the step of selecting the optimal processor according to a plurality of loading conditions corresponding to the plurality of processors.

6. The method of claim 5, wherein the plurality of loading conditions are predetermined.

7. The method of claim 5, wherein the plurality of loading conditions are based on corresponding historical loading condition data collected from real-time operation of the plurality of processors.

8. The method of claim 5, wherein during the selecting step, the optimal one of the plurality of processors is selected according to an optimal pair of the plurality of projected energy consumptions and loading conditions each weighted by predetermined criteria.

9. The method of claim 1, wherein during the selecting step, the optimal one of the plurality of processors is selected according to an optimal combination of one among the plurality of projected energy consumptions of the service application and the group comprising in combination a plurality of loading conditions corresponding to the plurality of processors, remaining energy in a battery supplying energy to the processing system, speed of processing for each of the plurality of processors, and a priority applied to the service application.

10. A mobile device, comprising:
a processing system comprising:
an inter-processor manager; and
a plurality of processors coupled to the inter-processor manager;
wherein two or more of the plurality of processors are capable of processing a service application, and wherein the inter-processor manager is programmed to:
receive a request to delegate the service application to at least one of the plurality of processors;
select an optimal one of the plurality of processors to execute the service application according to a plurality of projected energy consumptions of the service application corresponding to each of the plurality of processors if no historical data has been developed on the service applications
if historical data has been developed switching to an optimal one of the plurality of processors based on historical energy consumption data collected from real-time operation of a particular service application; and
delegate the service application to the optimal processor for execution.

11. The mobile device of claim 1 0, further comprising a wireless transceiver for transmitting and receiving radio messages to and from a communication system.

12. The mobile device of claim 10, wherein the mobile device is a mobile radio device further comprising:
a display coupled to processing system for providing images to a user of the mobile radio device;
an input and output port coupled to the processing system for receiving and transmitting signals into and out of the mobile radio device via a wireless transceiver; and
an audio system coupled to the processing system for accepting and providing audio signals to the user, wherein the display, wireless transceiver, and audio system have corresponding service applications.

13. The mobile device of claim 10, wherein the plurality of projected energy consumptions of the service application are predetermined.

14. The mobile device of claim 10, wherein the plurality of projected energy consumptions of the service application are based on corresponding historical energy consumption data collected from real-time operation of the service application on at least one of the plurality of processors.

15. The mobile device of claim 10, wherein the optimal one of the plurality of processors has the lowest projected energy consumption of the plurality of projected energy consumptions of the service application.

16. The mobile device of claim 10, wherein the selecting step further comprises the step of selecting the optimal processor according to a plurality of loading conditions corresponding to the plurality of processors.

17. The mobile device of claim 16, wherein the plurality of loading conditions are predetermined.

18. The mobile device of claim 16, wherein the plurality of loading conditions are based on corresponding historical loading condition data collected from real-time operation of the plurality of processors and wherein the interprocessor manager further weighs the selection among the plurality of processors based on an impact to battery life of the mobile device and wherein the corresponding historical loading condition data is further translated into energy consumption rates for the plurality of processors.

19. The mobile device of claim 16, wherein the selecting step, the optimal one of the plurality of processors is selected according to an optimal pair of the plurality of projected energy consumptions and loading conditions each weighted by predetermined criteria.

20. The mobile device of claim 10, wherein the selecting step, the optimal one of the plurality of processors is selected according to an optimal combination of projected energy consumptions of the service application in combination with a plurality of loading conditions corresponding to the plurality of processors, remaining energy in a battery supplying energy to the mobile device, speed of processing for each of the plurality of processors, and a priority applied to the service application
